(19) United States
(12) Patent Application Publication
(10) Pub. No.: US 2005/0047318 A1
(43) Pub. Date: Mar. 3, 2005

(54) Method of detecting land pre-pit signal and optical disk player

(76) Inventor: Hisashi Sakata, Ueda-shi (JP)

Correspondence Address: BIRCH STEWART KOLASCH & BIRCH, PO BOX 747, FALLS CHURCH, VA, 22040-0747, US

(21) Appl. No.: 10/918,394

(22) Filed: Aug. 16, 2004

(30) Foreign Application Priority Data
Aug. 29, 2003 (JP) 2003-305754

(51) Int. Cl. G11B 7/00; G11B 5/09

(52) U.S. Cl. 369/124.15; 369/47.27; 369/124.05

(57) ABSTRACT

The method of the present invention is capable of securely detecting LPP signal. The method of detecting LPP signal from a DVD comprises the steps of: reading a push-pull signal including a wobble component and an LPP component; and slice-shaping the push-pull signal with a prescribed slice signal so as to binarize the LPP component and detect the LPP signal. The method is characterized by: forming a through rate signal, whose amplitude and cycle are equal to those of the wobble component, from the push-pull signal; holding voltage of around a maximum peak or a minimum peak of the through rate signal; shaping the through rate signal so as to form a peak holding signal; and using the peak holding signal as the slice signal.

### BACKGROUND OF THE INVENTION

The present invention relates to a method of detecting land pre-pit (LPP) signals, in which a push-pull signal read from a digital video disk (DVD), which includes a groove and land pre-pits formed in the groove, is slice-shaped by a slice signal so as to detect LPP signals formed by binarizing LPP components, and an optical disk player performing said method.

The DVD is a data-writable DVD, e.g., DVD-R, DVD-RW, DVD+R, DVD+RW.

A phase changing material, whose phase changes between a crystal phase and a non-crystal phase, is used as a recording layer of the DVD. The recording layer is protected by a protection layer. A reflection layer is formed on the opposite side of the recording layer. The recording layer, the protection layer and the reflection layer are sandwiched between transparent plates, which are made of polycarbonate.

The recording layer of the DVD is shown in FIG. 7.

A groove 5 is spirally formed in the recording layer so as to guide a laser beam. A land 7 is spirally formed along the groove 5. The land 7 is projected from a surface of the recording layer. When the laser beam irradiates the surface of the recording layer, the phase changing material is phase-changed. The groove 5 is wobbled or meandered with a prescribed cycle. Time data can be given to an optical disk player on the basis of the cycle. Namely, the optical disk player detects wobble signals, which are based on the wobble groove 5, as time data, so as to control rotation of the disk.

Especially, in a DVD-R disk, DVD-RW disk, etc., land pre-pits (LPP) 9 are formed, as isolating pits, in the groove 5 at regular intervals. In the optical disk player, LPP signals having a prescribed cycle are used as time data for position control when data are written in the disk.

On the other hand, in an optical disk player for driving a DVD, an optical pick-up irradiate a laser beam toward the DVD and receives a beam reflected from the DVD. A light receiving element of the optical pick-up has a plurality of light receiving faces. Intensity of the reflected beam received by the light receiving faces are compared. A push-pull signal is generated on the basis of differences of the intensity of the reflected beam compared.

The push-pull signal is shown in FIG. 8.

The push-pull signal “a” is constituted by a wobble component “b”, whose amplitude and wave length correspond to the wobble or the meander of the groove 5, and pulse-shaped LPP components “c”, which correspond to the LPPs and which appears at regular intervals.

The LPP components “c” are projected from maximum or minimum peaks of the wobble component “b”, whose wave form is similar to a sine wave.

To extract the LPP components “c” from the push-pull signal “a”, signal levels are usually detected.

When the LPP components “c” exist at the peaks of the wobble component “b”, signals whose voltage is higher than specific signals, which have a prescribed voltage, are regarded as the LPP components “c”. The specific signals having the prescribed voltage are called slice signal. Namely, the push-pull signal “a” is compared with the slice signal, then the components “c” whose voltage are higher than the voltage of the slice signal is extracted as the LPP components “c”. The LPP components “c” are binarized as LPP signals. This method is disclosed in, for example, Japanese Patent Gazette No. 2003-123260.

In FIG. 9, the slice signal “d” is formed by through-rate-processing the push-pull signal “a”. Conventionally, amplitude, wave length and phase of the “d” is equal to those of the wobble component “b”. In the present specification, the signals are called through rate signal.

In the case of slice-shaping the push-pull signal “a”, the slice signal “d” is very close to the wobble component “b” so as to securely detect the LPP signals. Thus, the peaks of the wobble component “b” are slice-shaped by tracing the peaks.

However, the wobble component “b” of the push-pull signal “a” often includes noises “n”. Therefore, if the slice signal “d” is too close to the wobble component “b”, the noises “n” are detected, so that the LPP signals cannot be securely detected.

Especially, in the case of using the through rate signal as the slice signal “d”, the noises “n”, which exist in portions including no LPP components, are detected when the slice signal “d” is close to the wobble component “b”. Therefore, it is difficult to define the slice signal “d” very close to the peaks of the wobble component “b”.

### SUMMARY OF THE INVENTION

The inventor of the present invention has studied to solve the above described problem, and he found that the LPP components at the peaks of the push-pull signal can be securely detected, without detecting noises, by employing slice signal, which corresponds to the peaks and whose wave form except the parts corresponding to the peaks is separated from the wobble component.

An object of the present invention is to provide a method of securely detecting LPP signals.

Another object is to provide an optical disk player capable of performing said method.

To achieve the objects, the present invention has following structures.

Namely, the method of detecting a land pre-pit (LPP) signal from a digital video disk (DVD), in which a land pre-pit is formed in a groove,

comprises the steps of:

reading a push-pull signal including a wobble component and an LPP component, which appears at a peak of the wobble component; and

slice-shaping the push-pull signal with a prescribed slice signal so as to binarize the LPP component and detect the LPP signal,

the method is characterized by:

forming a through rate signal, whose amplitude and cycle are equal to those of the wobble component, from the push-pull signal;

holding voltage of one of a maximum peak and a minimum peak of the through rate signal and its vicinity;

shaping the through rate signal by removing the other peak thereof so as to form a peak holding signal; and

using the peak holding signal as the slice signal.

In the method of the present invention, the push-pull signal is slice-shaped by the peak holding signal, whose waveform is partially similar to that of the vicinity of the peak of the wobble component and whose waveform of other parts are not similar to that of the wobble component. Therefore, the vicinity of the peak of the push-pull signal can be slice-shaped by tracing the vicinity of the peak of the wobble component, so that the LPP component can be securely detected. On the other hand, other parts of the push-pull signal are slice-shaped at positions separated from the wobble component, so that no noises can be extracted. Therefore, only the LPP component can be securely and correctly detected. In the method, the peak holding signal may be a smooth signal, which is formed by smoothing the through rate signal by a smoothing circuit.

In the method, the peak holding signal may be a clip signal, which is formed by removing prescribed parts of the through rate signal, whose voltages are higher and lower than a prescribed voltage, by a clipping circuit.

The optical disk player of the present invention comprises:

an optical pick-up reading a push-pull signal including a wobble component and a land pre-pit (LPP) component, which appears at a peak of the wobble component, from a digital video disk (DVD), in which a land pre-pit is formed in a groove;

LPP signal detecting means for slice-shaping the push-pull signal with a slice signal so as to binarize the LPP component and detect an LPP signal;

means for forming the slice signal,

wherein the slice signal forming means includes:
means for forming a through rate signal, whose amplitude and cycle are equal to those of the wobble component, from the push-pull signal; and
peak holding signal forming means for holding voltage of one of a maximum peak and a minimum peak of the through rate signal and its vicinity and shaping the through rate signal by removing the other peak thereof so as to form a peak holding signal, and

wherein the peak holding signal is sent to the LPP signal detecting means as the slice signal.

In the optical disk player of the present invention, the vicinity of the peak of the push-pull signal can be slice-shaped by tracing the vicinity of the peak of the wobble component, so that the LPP component can be securely detected. On the other hand, other parts of the push-pull signal are slice-shaped at positions separated from the wobble component, so that no noises can be extracted. Therefore, only the LPP component can be securely and correctly detected.

In the optical disk player, the peak holding signal may be a smooth signal, which is formed by smoothing the through rate signal by a smoothing circuit.

In the optical disk player, the peak holding signal may be a clip signal, which is formed by removing prescribed parts of the through rate signal, whose voltages are higher and lower than a prescribed voltage, by a clipping circuit.

### BRIEF DESCRIPTION OF THE DRAWINGS

Embodiments of the present invention will now be described by way of examples and with reference to the accompanying drawings, in which:

FIG. 1 is a block diagram of a first embodiment of the optical disk player of the present invention;

FIG. 2 is a circuit diagram of an example of a smoothing circuit;

FIGS. 3A-3C are waveform charts showing a process of forming a slice signal from push-pull signal;

FIG. 4 is a waveform chart showing a process of slice-shaping the push-pull signal with a smooth signal;

FIG. 5 is a block diagram of a second embodiment of the optical disk player;

FIG. 6 is a waveform chart showing a process of slice-shaping the push-pull signal with a clip signal;

FIG. 7 is an explanation view of a recording layer of a DVD;

FIG. 8 is a waveform chart of the push-pull signal; and

FIG. 9 is a waveform chart showing the conventional process of slice-shaping the push-pull signal with the slice signal.

### DETAILED DESCRIPTION OF THE EMBODIMENTS

Preferred embodiments of the present invention will now be described in detail with reference to the accompanying drawings.

Note that, the feature of the present invention is to use a slice signal, whose waveform is similar to around peaks of a wobble component but not similar to other parts thereof, so as to slice-shape a push-pull signal and detect LPP signals, so that the LPP signals can be securely detected without detecting noises.

(First Embodiment)

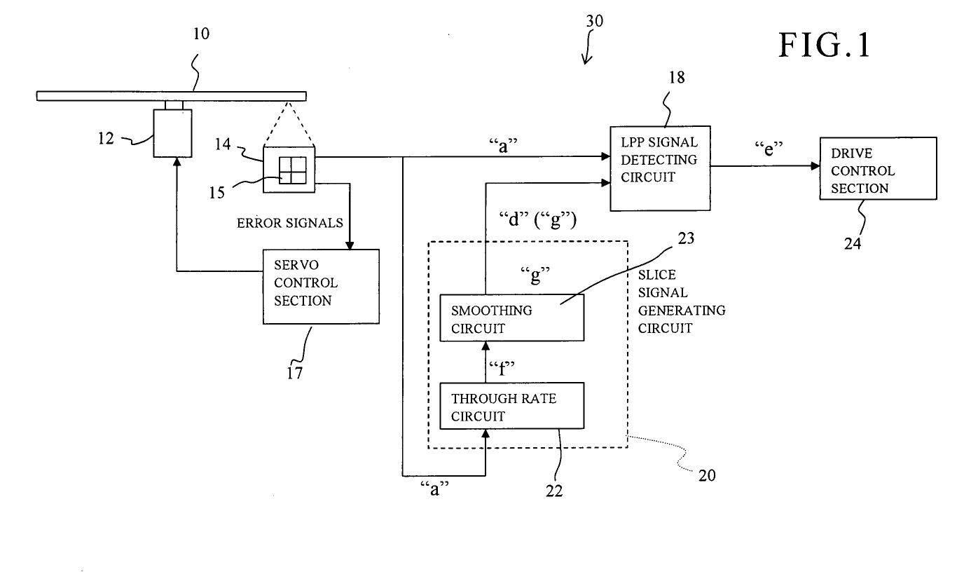

FIG. 1 shows a block diagram of a first embodiment of the optical disk player of the present invention, in which LPP signals are detected from a DVD including LPPs. The structure of the DVD is shown in FIG. 7 and described in BACKGROUND OF THE INVENTION. Note that, in the present embodiment, the optical disk player 30 is capable of writing data in and reading data from not only the DVD but also a CD.

An optical disk 10, e.g., DVD, is rotated by a spindle motor 12. An optical pick-up 14 is moved in the radial direction of the optical disk 10 so as to write data in and read data from the optical disk 10.

The optical pick-up 14 includes a laser diode (not shown) irradiating a laser beam to the optical disk 10, an object lens (not shown) focusing the laser beam on the recording layer of the optical disk 10, a photo diode 15 receiving the laser beam reflected on the optical disk 10, etc.

The photo diode 15 has a plurality of light receiving faces. Intensities of the reflected beam respectively detected in the light receiving faces are compared. Then, push-pull signal “a” is read from the reflected beam on the basis of differenced of the intensities. The photo diode 15 can read not only the push-pull signal “a” but also tracking error signals, focusing error signals, etc. on the basis of the intensities detected in the light receiving faces. The error signals are sent to a servo control section 17 so as to servo-control a tracking servo mechanism, a focusing servo mechanism, a spindle servo mechanism, etc.

An LPP signal detecting circuit 18 is connected to the optical pick-up 14. In the present embodiment, the LPP signal detecting circuit 18 includes a comparator.

The push-pull signal “a”, which has been read by the optical pick-up 14, and a slice signal “d” is inputted to the LPP signal detecting circuit 18. The push-pull signal “a” are slice-shaped on the basis of voltage of the slice signal “d” so as to extract only LPP components “c” (see FIG. 8) included in the push-pull signal “a”. The LPP components “c” detected are binarized and formed into LPP signals “e”, which are digital signals.

The LPP signals “e” detected by the LPP signal detecting circuit 18 are inputted to a drive control section 24, which controls writing data, etc. The drive control section 24 uses the LPP signals “e” as time data so as to perform control actions.

A slice signal generating circuit 20 is connected to the LPP signal detecting circuit 18.

The slice signal generating circuit 20 includes a through rate circuit (filter circuit) 22 and a smoothing circuit 23. The push-pull signal “a” is sent from the optical pick-up 14 to the through rate circuit 22. Note that, in the present embodiment, the smoothing circuit 23 acts as the he peak holding signal forming means of claims.

Action of the slice signal generating circuit 20 will be explained. Firstly, the through rate circuit 22 extracts only prescribed components of the push-pull signal “a” having prescribed frequency, then generates a through rate signal “f”, whose amplitude and wave length are equal to those of the wobble component “b”. Next, the through rate signal “f” is inputted to the smoothing circuit 23 so as to generate smooth signals “g”.

The smooth signals “g” are sent to the LPP signal detecting circuit 18.

Note that, the through rate circuit 22 may be constituted by a band pass filter (not shown).

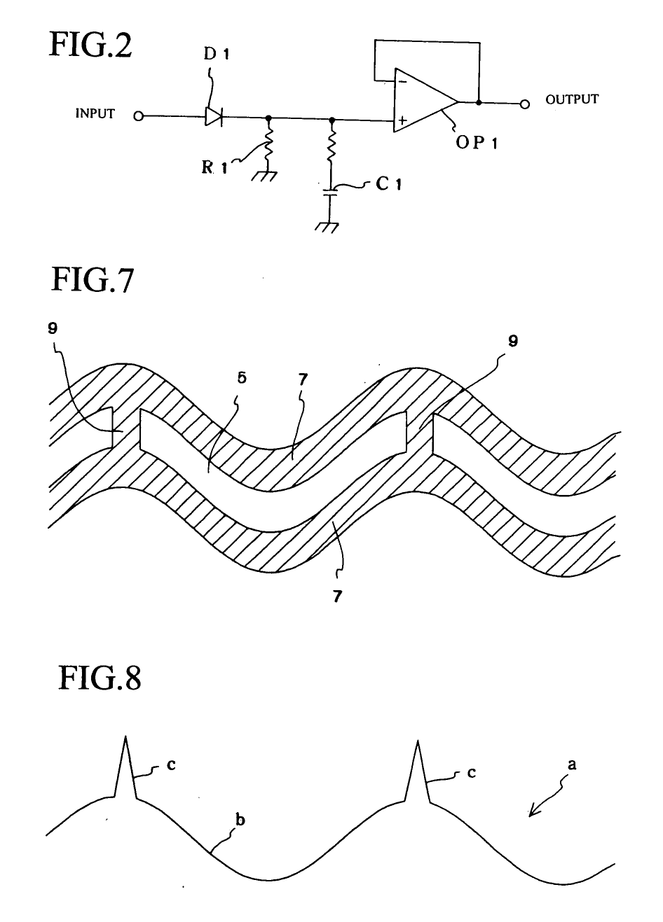

An example of the smoothing circuit 23 is shown in FIG. 2. In the smoothing circuit 23, lower parts of the through rate signal “f”, whose voltage is lower than predetermined voltage, is removed and half-wave-rectified by a diode 1 and a resistance “R”. Further, capacitor C1 smoothes around peaks of the signals “f”. The smooth signal “g” are outputted from an op-amp OP1. Note that, the op-amp OP1 is a voltage follower, which impedance-converts the rectified signals and outputs the converted signals.

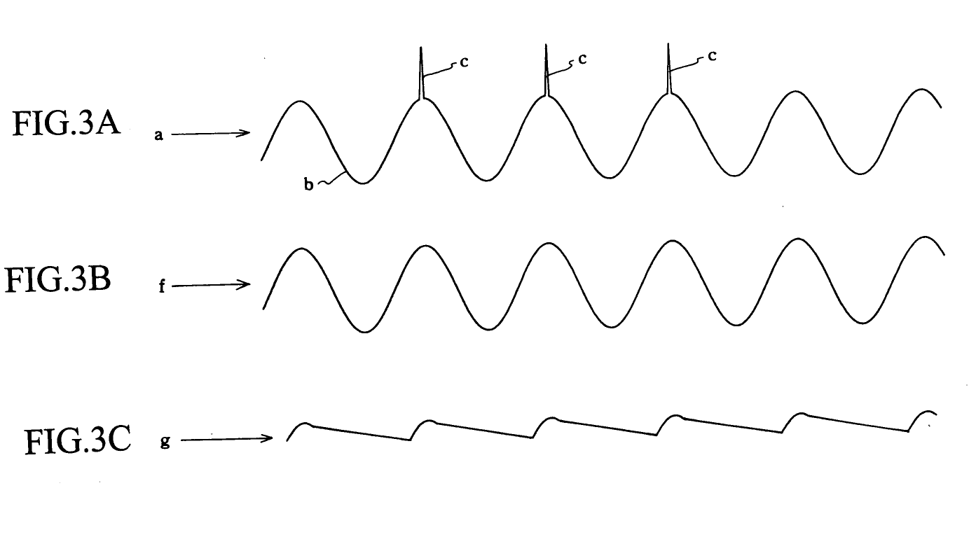

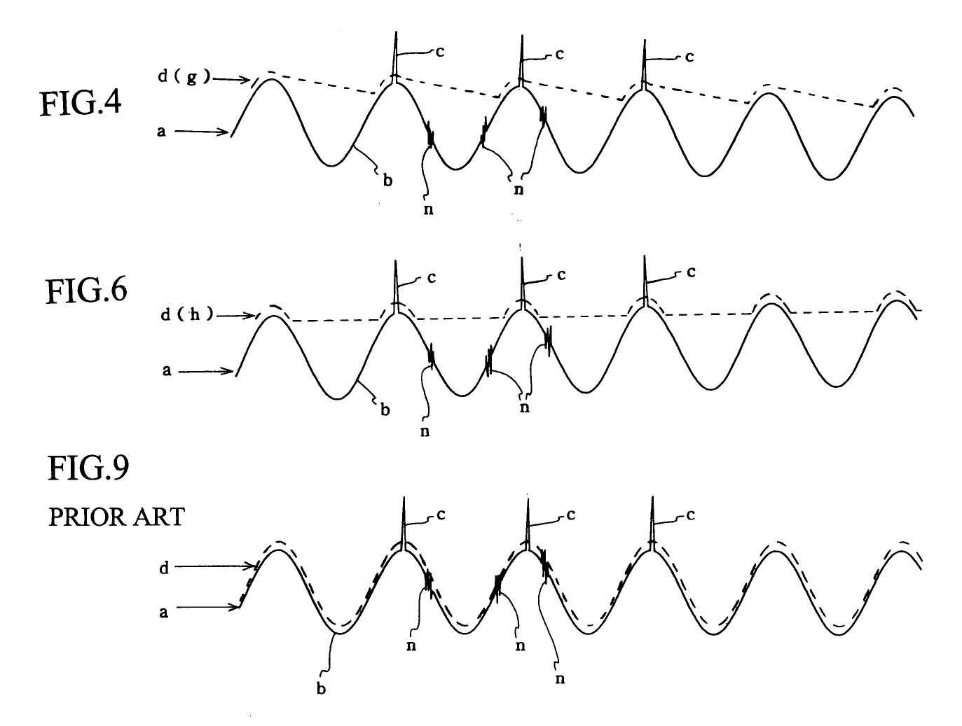

Next, a method of detecting the LPP signals “e” performed in the optical disk player 30 will be explained with reference to FIGS. 3A-4.

The push-pull signal “a” is shown in FIG. 3A. As described above, the push-pull signal “a” is generated on the basis of the reflected beam received by the optical pick-up 14. Namely, the reflected beam is received by a plurality of the light receiving faces of the photo detector 15, and differences of the intensities in the light receiving faces are detected so as to generate the push-pull signal “a”.

Since the groove 5 of the DVD 10 is wobbled or meandered and the LPPs are formed in the groove 5 (see FIG. 7), the push-pull signal “a” includes the wobble component “b” and the LPP components “c”.

When the push-pull signal “a” is inputted to the through rate circuit 22 of the slice signal generating circuit 20, only specific components having prescribed frequency are extracted so as to generate the through rate signal “f” shown in FIG. 3B. Amplitude and wave length of the through rate signal “f” are equal to those of the wobble component “b”.

The through rate signal “f” is inputted to the smoothing circuit 23. In the smoothing circuit 23, voltage around peaks of the through rate signal “f” are not shaped. Namely, voltage of the smooth signals “g” are gradually reduced from the peaks (see FIG. 3C); the smooth signals “g” have flat parts.

The smooth signals “g” are sent from the smoothing circuit 23 to the LPP signal detecting circuit 18 as the slice signal “d”.

In the LPP signal detecting circuit 18, the push-pull signal “a” is slice-shaped by the slice signal “d” (the smooth signal “g”). Namely, parts of the push-pull signal “a”, whose voltage is higher than voltage of the slice signal “d”, is extracted.

By using the smooth signal “g” as the slice signal “d”, the slice signal “d” corresponds to only the peaks of the wobble component “b” even if noises are included in the wobble component other than the peaks. Namely, the slice signal “d” corresponds to around the peaks only. Therefore, the LPP signal detecting circuit 18 can securely detect the LPP signals “e” without detecting noises “n”.

(Second Embodiment)

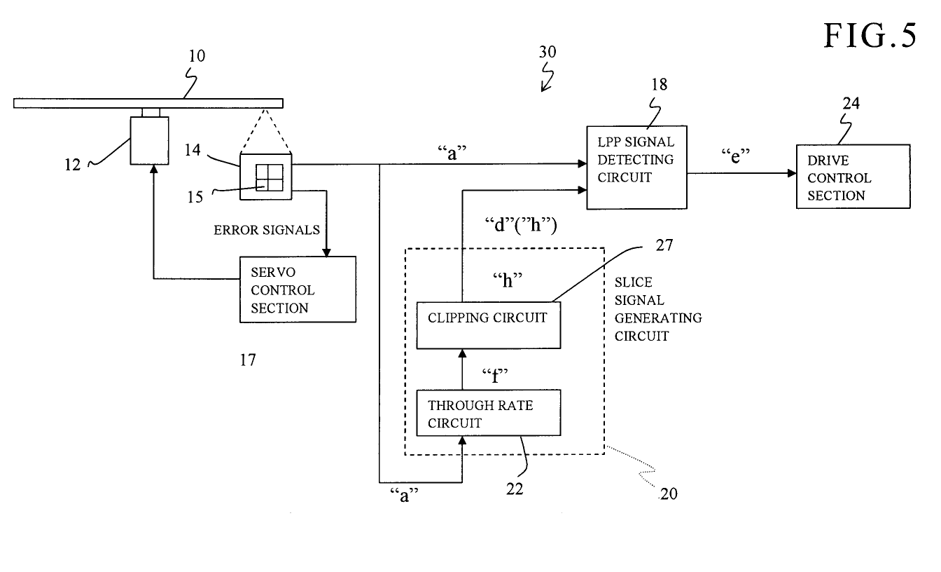

FIG. 5 shows a block diagram of a second embodiment of the optical disk player. Note that, elements explained the first embodiment are assigned the same reference symbols and explanation will be omitted.

In the present embodiment, a clip signal “h” is used as the slice signal “d” instead of the smooth signals “g” of the first embodiment.

The slice signal generating circuit 20 includes the through rate circuit (filter circuit) 22 and a clipping circuit 27. The push-pull signal “a” is sent from the optical pick-up 14 to the through rate circuit 22. Note that, in the present embodiment, the clipping circuit 27 acts as the he peak holding signal forming means of claims. A known clipping circuit may be used as the clipping circuit 27.

Action of the slice signal generating circuit 20 will be explained. Firstly, the through rate circuit 22 extracts only prescribed components of the push-pull signal “a” having prescribed frequency, then generates through rate signal “f”, whose amplitude and wave length are equal to those of wobble component “b”. Next, the through rate signal “f” is inputted to the clipping circuit 27 so as to generate a clip signal “h”.

The clip signal “h” is sent to the LPP signal detecting circuit 18 as the slice signal “d”.

The slice-shaping the push-pull signal “a” with the clip signal “h” will be explained with reference to FIG. 6.

In the clipping circuit 27, voltage around peaks of the through rate signal “f” are not shaped. Namely, voltage of the clip signal “h” is fixed other than around the peaks; the clip signal “h” has flat parts.

The clip signal “h” is sent from the clipping circuit 27 to the LPP signal detecting circuit 18 as the slice signal “d”.

In the LPP signal detecting circuit 18, the push-pull signal “a” is slice-shaped by the slice signal “d” (the clip signal “h”). Namely, parts of the push-pull signal “a”, whose voltage is higher than voltage of the slice signal “d”, is extracted.

By using the clip signal “h” as the slice signal “d”, the slice signal “d” corresponds to only the peaks of the wobble component “b” even if noises are included in the wobble component other than the peaks. Namely, the slice signal “d” corresponds to around the peaks only. Therefore, the LPP signal detecting circuit 18 can securely detect the LPP signals “e” without detecting noises “n”.

In the first and second embodiments, the LPP components “c” are projected (upward in the waveform) from the maximum peaks of the wobble component “b”.

In the case that the LPP components “c” are projected (downward in the waveform) from the minimum peaks of the wobble component “b”, voltage around the minimum peaks of the through rate signal “f” are held, as the slice signal “d”, by the smoothing circuit 23 or the clipping circuit 27. The invention may be embodied in other specific forms without departing from the spirit of essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

1. A method of detecting a land pre-pit (LPP) signal from a digital video disk (DVD), in which a land pre-pit is formed in a groove,
comprising the steps of:
reading a push-pull signal including a wobble component and an LPP component, which appears at a peak of the wobble component; and
slice-shaping the push-pull signal with a prescribed slice signal so as to binarize the LPP component and detect the LPP signal,
characterized by:
forming a through rate signal, whose amplitude and cycle are equal to those of the wobble component, from the push-pull signal;
holding voltage of one of a maximum peak and a minimum peak of the through rate signal and its vicinity;
shaping the through rate signal by removing the other peak thereof so as to form a peak holding signal; and
using the peak holding signal as the slice signal.

2. The method according to claim 1,
wherein the peak holding signal is a smooth signal, which is formed by smoothing the through rate signal by a smoothing circuit.

3. The method according to claim 1,
wherein the peak holding signal is a clip signal, which is formed by removing prescribed parts of the through rate signal, whose voltages are higher and lower than a prescribed voltage, by a clipping circuit.

4. An optical disk player,
comprising:
an optical pick-up reading a push-pull signal including a wobble component and a land pre-pit (LPP) component, which appears at a peak of the wobble component, from a digital video disk (DVD), in which a land pre-pit is formed in a groove;
LPP signal detecting means for slice-shaping the push-pull signal with a slice signal so as to binarize the LPP component and detect an LPP signal;
means for forming the slice signal,
wherein said slice signal forming means includes:
means for forming a through rate signal, whose amplitude and cycle are equal to those of the wobble component, from the push-pull signal; and
peak holding signal forming means for holding voltage of one of a maximum peak and a minimum peak of the through rate signal and its vicinity and shaping the through rate signal by removing the other peak thereof so as to form a peak holding signal, and
wherein the peak holding signal is sent to said LPP signal detecting means as the slice signal.

5. The optical disk player according to claim 4,
wherein the peak holding signal forming means is a smoothing circuit smoothing the through rate signal.

6. The optical disk player according to claim 4,
wherein the peak holding signal forming means is a clipping circuit removing prescribed parts of the through rate signal, whose voltages are higher and lower than a prescribed voltage.
